(19) United States
(12) Patent Application Publication
(10) Pub. No.: US 2006/0246395 A1
(43) Pub. Date: Nov. 2, 2006

(54) Prophy angle and handheld device for applying dental materials

(76) Inventor: Gary J. Pond, Racine, WI (US)

Correspondence Address: RYAN KROMHOLZ & MANION, S.C., POST OFFICE BOX 26618, MILWAUKEE, WI, 53226, US

(21) Appl. No.: 11/405,254

(22) Filed: Apr. 17, 2006

Related U.S. Application Data
(63) Continuation-in-part of application No. 10/667,164, filed on Sep. 17, 2003, now Pat. No. 7,029,278.
(60) Provisional application No. 60/411,297, filed on Sep. 17, 2002.

(51) Int. Cl. A61C 3/06

(52) U.S. Cl. 433/125

(57) ABSTRACT

A dental handpiece for applying dental material to polish a tooth. The handpiece includes a conduit and a plunger for dispensing dental material adjacent a polishing member. The plunger and the polishing member can be controlled by a drive means, which may move in both a forward and reverse direction. A removable prophy angle may contain the dental material.

### RELATED APPLICATION

This is a continuation-in-part application of co-pending U.S. patent application Ser. No. 10/667,164, filed on 17 Sep. 2003, which claims the benefit of U.S. provisional patent application Ser. No. 60/411,297, filed 17 Sep. 2002, now abandoned.

### BACKGROUND OF THE INVENTION

The present invention relates generally to a dental handpiece, and more specifically to a dental handpiece adapted to apply dental material to a patient's tooth or teeth and having removable sections.

Dental handpieces for dispensing dental material are well known in the art. For example Charlton (U.S. Pat. No. 6,083,000) and Lewis (U.S. Pat. No. 3,389,3468) are designed to distribute dental material in a controlled fashion. Generally, a predetermined amount of dental material is stored in a reservoir within the handpiece and a longitudinally moving plunger pushes a plug into the reservoir, dispensing the dental material in a controlled fashion. The dental material may be loaded directly within the reservoir or contained within a capsule that is placed within the reservoir.

Although dental handpieces and disposable capsules have become a convenient way to dispense a controlled amount of dental material into a patient's mouth, the handpieces do not necessarily provide the most sterile environment. Though capsules of dental material can be measured for a single patient use, there still may be residue dental material in the handpiece itself after use. Especially when a corkscrew style plunger is used, the handpiece may not be sufficiently cleaned or sterilized between consecutive patients. The dental material is not easily washed out of the devices, and one cannot be certain that the material has been completely removed.

For the foregoing reasons, there is a need for a device that will allow a dentist, hygienist, or a dental assistant to dispense a controlled amount of dental material into a patient's mouth in a manner that is efficient and hygienic.

### SUMMARY OF THE INVENTION

The present invention alleviates the above problem by disclosing a dental handpiece that is easily kept clean and sterile. The handpiece is designed generally to dispense prophy paste or similar material in a safe, sanitary manner.

The handpiece comprises a detachable shield that fits securely onto the body of the handpiece. The shield contains a conduit passing through the shield. At one end the conduit is in fluid communication with a reservoir of dental material, and the opposing end of the conduit is in fluid communication with the area where the dental material will be dispensed. Once the shield has been used, it may be removed and discarded, or autoclaved if preferred. The disposable shield helps ensure that residual dental material will not pass from one application to the next.

Along with the shield, the reservoir for the dental material contributes to the sanitary nature of the invention. The reservoir is adapted to receive a cartridge of dental material having opposing ends. One end of the capsule is in fluid communication with a conduit located in the shield, while the opposite end is in communication with a plunger. The plunger pushes the dental material through the reservoir so that the dental material may enter the conduit located in the shield. Because of the design of the reservoir, plunger, and the cartridge, the dental material has minimal contact with the walls of the reservoir, and the cartridge may be discarded after being used, thereby contributing to the overall sanitary features of the handpiece. Likewise, the design prevents dental material from coming in contact with any of the mechanical parts of the handpiece.

The plunger pushes the dental material through the conduit in the shield, allowing the material to exit at an area where a tooth is to be polished by a rotating polishing device, such as a prophy cup.

The plunger can be operated manually, but is preferably driven by a drive mechanism located within the body of the handpiece. The plunger has a semi-helical design, which meshes with a gear or cog connected to the drive mechanism. The drive mechanism also drives the polishing device or other attachment located on the end of the handpiece. A reversible direction trigger controls the drive mechanism, allowing easy control of the handpiece. The drive mechanism is enclosed within the body of the handpiece and does not come into contact with the dental material.

The overall design allows for an efficient dental handpiece with improved sanitary operating conditions. Dental material will generally be completely removed after each application, and the mechanical features of the device will not come into contact with the dental material.

The dental material may also be incorporated into the shield itself, either within a reservoir formed in the shield or by having the cartridge insertable into a receptacle formed in the shield. The shield may essentially be incorporated together with the prophy angle as a removable device to the handpiece itself, having the dental material in a segregated pathway from the drive mechanism or drive shaft of the device. This segregated prophy angle as described herein is a further improvement over the prior art.

These and other advantages will become more evident in the following description.

### DESCRIPTION OF THE DRAWINGS

FIG. 1 is an exploded perspective view of an embodiment of the current invention.

FIG. 2 is a perspective view of an embodiment of the current invention.

FIG. 3 is a cutaway view of the invention shown in FIG. 2.

FIG. 4 shows a cutaway view of the present invention in use by a person.

FIG. 5 shows a cutaway view of the present invention after a user has finished applying a dental material.

FIG. 6 is a partially cut-away side elevation view of a second embodiment of the current invention.

FIG. 7 is a perspective view of the embodiment of FIG. 6.

FIG. 8 is a partially cut-away side elevation view of the embodiment of FIG. 6 having an alternate reservoir arrangement.

FIG. 9 is a perspective view of the device of FIG. 8, further showing a secondary entrance for the reservoir.

### DETAILED DESCRIPTION

Although the disclosure hereof is detailed and exact to enable those skilled in the art to practice the invention, the physical embodiments herein disclosed merely exemplify the invention that may be embodied in other specific structures. While the preferred embodiment has been described, the details may be changed without departing from the invention, which is defined by the claims.

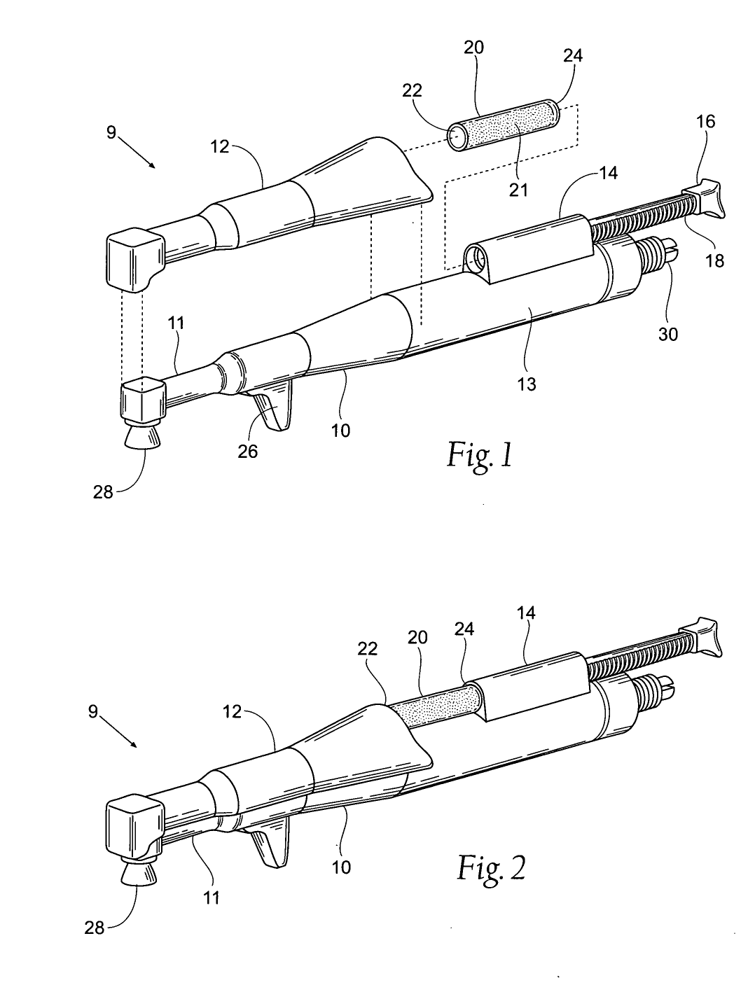

FIG. 1 shows an exploded view of a handpiece 9 in accordance with the present invention. The handpiece 9 has a body 10 that allows a user to engage the handpiece 9. A removable shield 12 fits securely onto a front portion 11 of the body 10. A reservoir 14 sits on a back portion 13 of the body 10. The reservoir 14 and the body may be formed from one piece of material or separate pieces. The reservoir 14 is in communication with a plunger 16 having a helical underside 18. The reservoir 14 will also contain a through cartridge 20 containing a dental material or prophy paste 21. The cartridge 20 has a first end 22 and a second end 24. The first end 22 can be sealed, while the second end 24 is generally open. The second end 24 may contain a removable cover (not shown) for when the cartridge 20 is not in use. A trigger device 26 is connected to the body 10 and can control the action of a polishing member 28. An adaptor 30 allows the handpiece 9 to be powered from a power source, preferable an air source, but any suitable power source will be allowed (not shown).

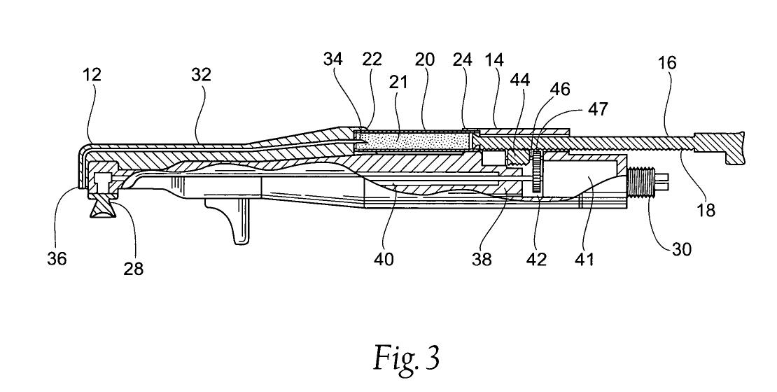

FIG. 2 shows a perspective view of the handpiece 9 of the present invention. The shield 12 fittingly sits on the front end 11 of the body 10 and protects the body 10 from undue splatter when the polishing member 28 is in use. The cartridge 20 fits securely between the reservoir 14 and the shield 12, with a portion of the cartridge 20 secured inside of the reservoir 14. Generally, the cartridge 20 will be secured in the handpiece 9 before the shield 12 is secured on the handpiece 9. The opposing ends 22 and 24 are in fluid communication with the shield 12 and the reservoir 14, respectively. This communication can be seen clearer in FIG. 3.

FIG. 3 is a sectional view of the handpiece 9. The shield 12 has a through conduit 32 having a proximal end 34 and a distal end 36. The distal end 36 is located near the polishing member 28 and allows an exit for the dental material 21. The proximal end 34 is in fluid communication with the first end 22 of the cartridge 20. The proximal end 34 is sharpened so that it can pierce and penetrate the closed first end 22 of the cartridge 20. This ensures that the dental material 21 will only be delivered into the conduit 32 of the shield, rather into or onto the handpiece 9. As a safety measure, the proximal end 34 preferably does not extend past the end of the shield 12.

Still referring to FIG. 3, the second end 24 of the cartridge 20 is secured within the reservoir 14. The cartridge 20 is shown protruding out of the reservoir 14, but it is possible that the reservoir 14 would encompass most or the entire cartridge 20. The second end 24 is arranged so that it will be able to receive the plunger 16. The helical underside 18 of the plunger 16 is in contact with a threaded cog 44. The helical underside 18 meshes with the cog 44, and as the cog 44 turns, the plunger 16 is moved forward to engage the dental material 21 within the cartridge 20. If the plunger 16 is to be withdrawn, the cog 44 is rotated in the opposite direction and the plunger 16 moves backward. While the design of the plunger 16 allows it to move backward and forward without rotating, it is also conceivable that the plunger 16 may be designed to rotate.

Essentially a drive mechanism 38 drives the cog 44. The drive mechanism 38 consists of a main drive shaft 40, a motor 41, a main drive gear 42, a secondary drive shaft 46, and a secondary drive gear 47. The drive mechanism 38 receives power through the adaptor 30, which can be joined to any suitable power source. Ideally, the device is driven with air as a power source, but any suitable power source is allowable.

The motor 41 turns the main drive gear 42. The teeth of the main drive gear 42 mesh with the teeth of the secondary drive gear 47. The main drive gear 42 will turn, thereby rotating the secondary drive gear 47, causing the secondary drive shaft 46 to rotate, as well. The secondary drive shaft 46 turns the cog 44, thereby moving the plunger 16, as stated above.

The main drive shaft 40 is connected to the polishing means 28. As the motor 41 turns the main drive gear 42, the main drive shaft 40 is also turned, thereby spinning the polishing means 28. In a preferred embodiment, the polishing means 28 is a prophy cup. The handpiece 9 is designed so that the polishing means 28 and the plunger 16 are rotated or moved concurrently, thereby allowing the user to manipulate a single control to polish a patient's tooth.

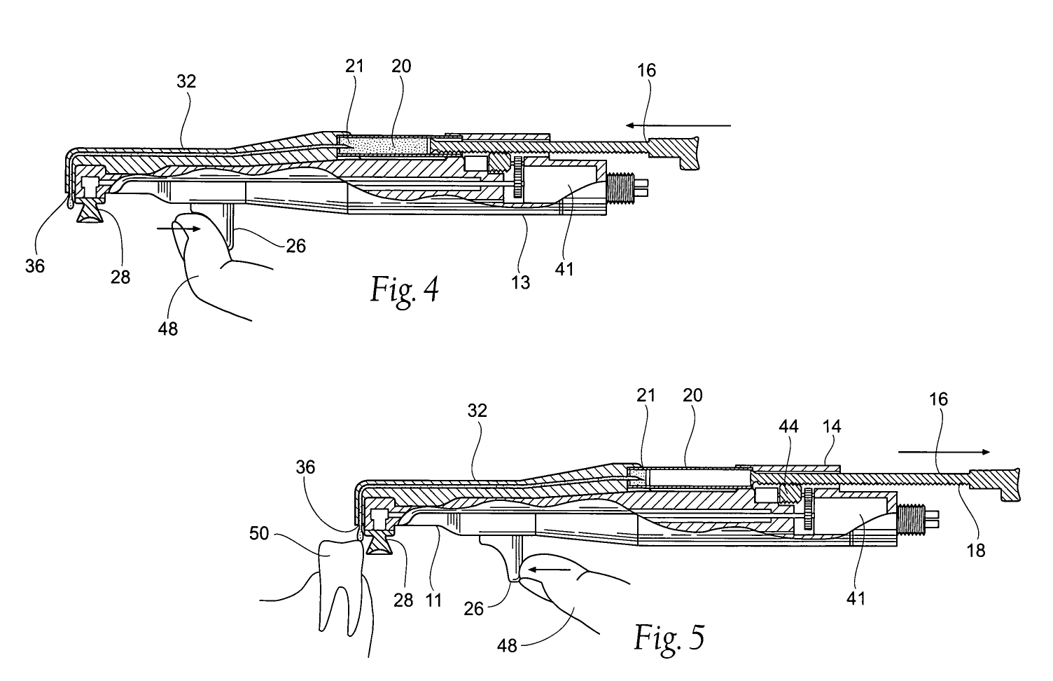

Referring to FIGS. 4 and 5 the handpiece 9 is shown engaged by a finger 48. The finger 48 makes contact with the trigger 26. The trigger is connected to and controls the motor 41, thereby controlling the drive mechanism 38. The trigger 26 allows for both a forward and reverse direction of the drive mechanism 38. As shown in FIG. 4, the drive mechanism 38 is activated by pulling the trigger 26 backwards toward the back portion 13 of the handpiece 9, allowing the plunger 16 to move forward and into the reservoir 14, contacting the cartridge 20 of dental material 21. The dental material 21 passes through the conduit 32 and exits at the distal end 36 of the conduit 32. The dental material 21 can then be deposited on a tooth 50 (see FIG. 5), which will be polished by the polishing means 28. If one wishes to stop the flow of dental material 21, one simply removes their finger from the trigger 26.

When the polishing is finished, the trigger 26 can be moved in the opposite direction towards the front portion 11 of the handpiece 9, as shown in FIG. 5, thereby causing the plunger 16 to withdraw from the reservoir 14 and the cartridge 20. The empty cartridge 20 may then be removed from the handpiece 9 and discarded. It is also possible that the plunger 16 may be designed so that one could manually disengage the helical side 18 of the plunger 16 from the cog 44 and be removed from the reservoir 14 manually. The cartridge 20 and the shield 12 are then discarded, or autoclaved if desired. The result is a polished tooth 50 and a handpiece 9 without residual dental material 21 built up on the handpiece 9.

While the drive mechanism 38 is described to control both the polishing means 28 and the plunger 16, it is foreseeable that they could be operated by separate controls. Also, if desired, the plunger 16 could be operated manually rather than by a motor, and the movement of the plunger 16 could also control the polishing means 28 without use of a motor.

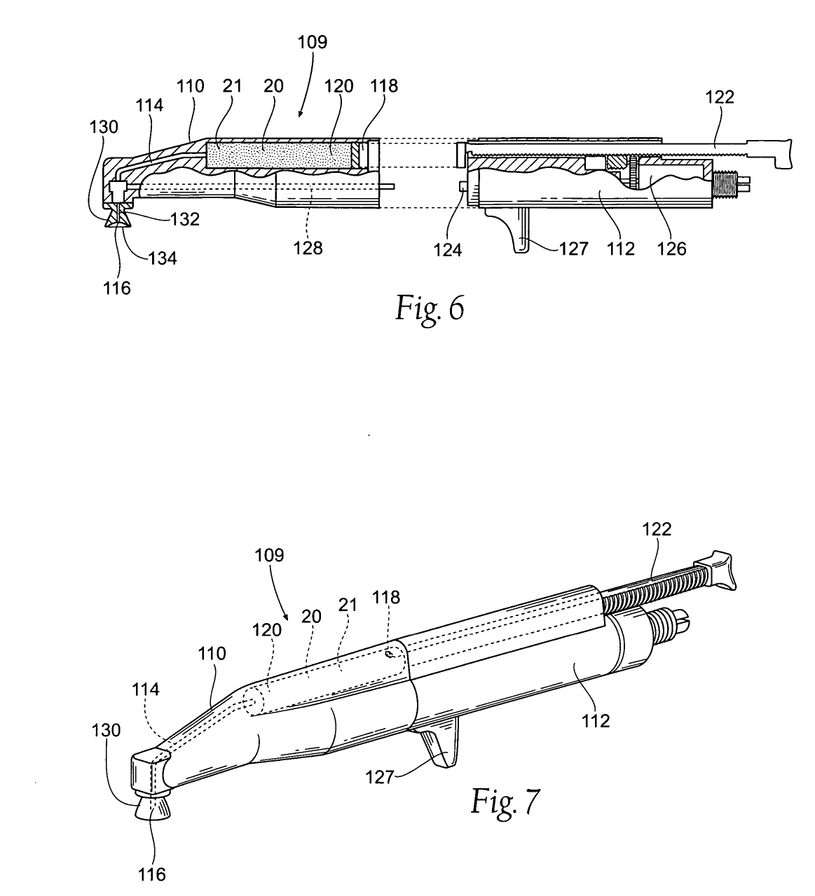

FIGS. 6 through 9 provide an alternate embodiment 109 of a handpiece according to the present invention. The general operations of the handpiece 109 are similar to the handpiece 9, except that the shield in the previous handpiece 9 has now been incorporated with a prophy angle. The handpiece 109 comprises a removable prophy angle 110 and an elongated handle 112. Specifically referring to FIGS. 6 and 7 the prophy angle 110 has a through conduit 114 having a distal end 116 and a proximal end 118. As shown in FIG. 6, a reservoir 120 is located within the through conduit 114, with the reservoir 120 containing dental material 21, preferably within a removable cartridge 20, as discussed with respect to FIGS. 1-5.

The prophy angle 110 is arranged to be received by the elongated body 112. The elongated body 112 has a plunger 122 and a drive member 124 connected to a drive mechanism 126, similar to the previously described handpiece 9 (see FIGS. 1-5). A control mechanism, preferably a reversible trigger 127, will control the drive mechanism 126, as described for the handpiece 9. As will be appreciated, other trigger styles may also be used with the device. For instance, triggers that may automatically retract when pressure is removed from the trigger, as known in the art, could be used in conjunction with the present device. Also, the plunger 122 will intersect the reservoir 120 as previously described. When engaged, the plunger 122 moves the dental material 21 towards the distal end 116 within the polishing member 130, thereby dispensing the dental material 21. The drive member 124 will be coupled to a drive shaft 128 located within the prophy angle 110. The drive shaft 128 and the drive member 124 may be coupled in any fashion or way known in the art. The drive shaft 128 further is connected to a polishing member 130, which allows the handpiece 109 to be used in a similar fashion to the handpiece 9. The polishing member 130 further comprises a channel 132, preferably located centrally with and coaxially within the polishing member 130. The channel 132 generally comprises the distal end 116 of the conduit and exits the polishing member 130 at an area 134 where the dental material 21 is applied. However, as noted with the previous embodiment, the dental material 21 is still applied through the conduit 114, without interfering with the drive shaft 128. Thus, keeping the through conduit 114 segregated from the drive shaft 128 allows the dental material 21 not to impede the movement of the drive shaft 128, as previously described in the previous embodiment. Also, the present handpiece 109 shows the dental material 21 being delivered through the polishing member 130. It is understood that placement of the distal end 116 of the through conduit 114 may be place internally or externally of the polishing member 130 and still fall within the scope of the present invention.

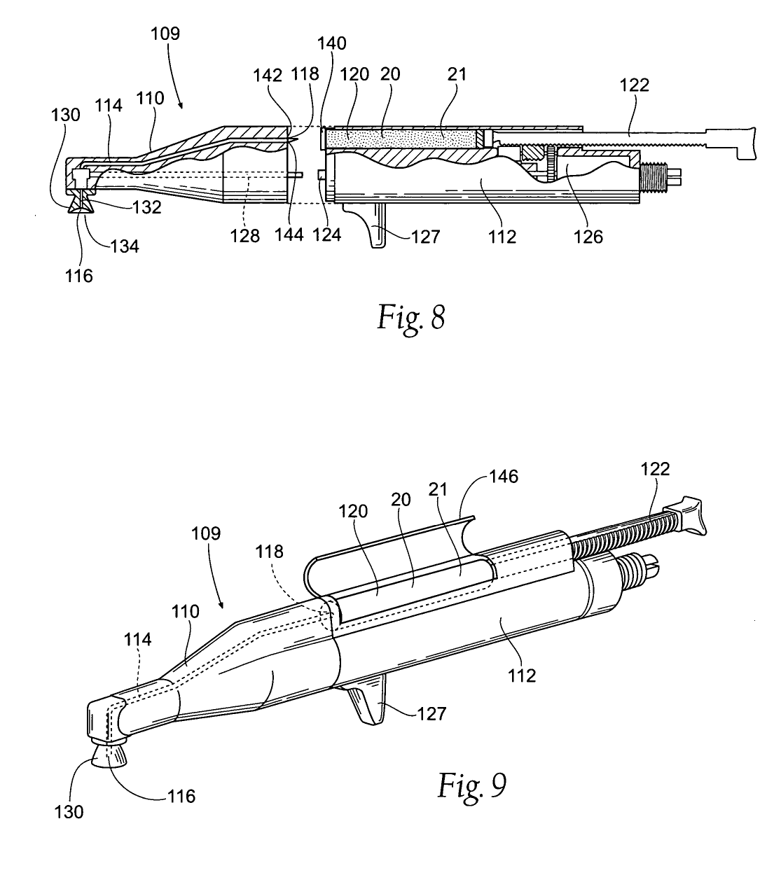

FIGS. 8 and 9 show the handpiece 109 with the reservoir 120 being located within the elongated body 112. As previously discussed, the reservoir 120 preferably contains the removable cartridge 20 that contains the dental material 21. The removable cartridge 20 or the reservoir 120 will have a seal 140 to prevent leakage of the dental material 21 before being used. The proximal end 118 of the through conduit 114 preferably is designed to include means 142 to puncture or break the seal 140. The puncture means 142 can be of any known design that will penetrate the reservoir 120 to sufficiently allow flow of dental material 21 towards the through conduit 114. The proximal end 118 is also preferably arranged to form sealing means 1424 for fluidly sealing the through conduit 114 and the reservoir 120. The term fluidly sealing should be understood to refer to a connection or arrangement that will sufficiently prevent the dental material to exit into the rest of the handpiece 109. For instance, the preferred dental material 21 is a fairly viscous material. A fluidly sealing arrangement would be sufficient to prevent the viscous material to exit into the rest of the handpiece 109 and does not necessarily have to be an airtight arrangement, though an airtight arrangement would fall within the scope of the aforesaid fluidly sealing arrangement.

FIG. 9 shows a door 146 located on the elongated body 112. This further eases placement of the removable cartridge 20 into the handpiece 109. This may be advantageous if more than one cartridge 20 would be used for a single dental procedure. Overall, the handpiece 109 is designed for ease of delivery of the dental material 21. Because of the possible viscous nature of the dental material, the less distance the material needs to travel, the less stress on the moving parts of the handpiece 109. The present invention achieves this goal without fouling the drive parts of the handpiece 109 by segregating the pathway of the dental material and the drive mechanism.

The dental material 21 may be delivered either directly through a polishing member or near a polishing member, from a reservoir either located within or outside of a detachable shield, or within or outside of a detachable prophy angle. It is understood that the scope of the present invention includes combinations as described above. Likewise, the delivery area of the dental material 21 should be understood to include the area where the dental material 21 will be used, regardless of whether the material travels through or adjacent to the polishing member.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A dental handpiece arranged for delivery of a dental material comprising:
a generally elongated body enclosing a drive member;
a reservoir to hold said dental material;
a removable prophy angle, said angle comprising:
a polishing member;
a drive shaft connecting said polishing member to said drive member;
a through conduit located in said prophy angle, said conduit having a distal end, said distal end in fluid communication with an area wherein said dental material may be applied adjacent said polishing member, said through conduit being segregated from said drive shaft; and
a plunger, said plunger in communication with said dental material.

2. The device according to claim 1 wherein said dental material is contained in a removable cartridge.

3. The device according to claim 2 wherein said prophy angle further comprises means for puncturing said removable cartridge.

4. The device according to claim 3 wherein said prophy angle further comprises means for fluidly sealing said reservoir and said through conduit.

5. The device according to claim 1 wherein said reservoir is located within said prophy angle.

6. The device according to claim 1 further comprising a control mechanism for said drive member.

7. The device according to claim 7 wherein the control mechanism is a reversible trigger.

8. The device according to claim 1 wherein said reservoir is located within said elongated body.

9. The device according to claim 8 wherein said dental material is contained in a removable cartridge, said elongated body further comprising an opening for insertion of said removable cartridge into said body.

10. The device according to claim 1 wherein said conduit further includes a proximal end, said proximal end being in sealable relationship with said reservoir.

11. The device according to claim 1 wherein said conduit further comprises a channel located within said polishing member, said channel in fluid communication with said area where said dental material may be applied.

12. A dental handpiece arranged for delivery of a dental material comprising:
a generally elongated body enclosing a drive member;
a reservoir to hold said dental material;
a removable prophy angle, said angle comprising:
a polishing member;
a drive shaft connecting said polishing member to said drive member;
a through conduit located in said shield, said through conduit segregated from said drive member, said conduit having a distal end, said distal end in fluid communication with an area wherein said dental material may be applied adjacent through polishing member;
a plunger, said plunger in communication with said dental material; and
a control mechanism connected to said drive member, said control mechanism controlling said drive member and said plunger.

13. The device according to claim 12, wherein the control mechanism is a reversible trigger.

14. The device according to claim 12 wherein said dental material in said reservoir is contained in a removable cartridge.

15. The device according to claim 14 wherein said prophy angle further comprises means for puncturing said removable cartridge.

16. The device according to claim 15 wherein said prophy angle further comprises means for fluidly sealing said reservoir and said through conduit.

17. The device according to claim 12 wherein said reservoir is located within said prophy angle.

18. In combination with a dental handpiece for delivering a dental material, said dental handpiece for delivering a dental material, said dental handpiece comprising a plunger, a drive member, and a drive mechanism for controlling said plunger and said drive member, a removable prophy angle for attachment to said dental handpiece said removable prophy angle comprising:
a polishing member;
a drive shaft connecting said polishing member to said drive mechanism; and
a through conduit, said through conduit being segregated from said drive shaft, said conduit having a distal end, said distal end in fluid communication with an area wherein said dental material may be applied adjacent said polishing member.

19. The prophy angle according to claim 18 wherein said dental material is located within a cartridge, said cartridge being removably insertable into said through conduit.

20. The prophy angle according to claim 19 further comprising:
means for puncturing said cartridge, said puncturing means further forming a fluid-tight seal with said reservoir.
